(19) United States
(12) Patent Application Publication
(10) Pub. No.: US 2021/0213753 A1
(43) Pub. Date: Jul. 15, 2021

(54) Recirculating Ink Cartridge for Aerosol Jet Printing

(71) Applicant: National Technology & Engineering Solutions of Sandia, LLC, Albuquerque, NM (US)

(72) Inventor: Ethan Benjamin Secor, Albuquerque, NM (US)

(21) Appl. No.: 16/743,720

(22) Filed: Jan. 15, 2020

(51) Int. Cl. B41J 2/18; B41J 2/175

(52) U.S. Cl. CPC B41J 2/18; B41J 2/17596; B41J 2/17566

(57) ABSTRACT

Aerosol jet printing offers a versatile, high-resolution capability for flexible and hybrid electronics. By integrating a flow-through ink cartridge with an ink recirculation system, ink composition and level within the cartridge are better maintained. This invention enables extended duration printing with improved deposition stability. This provides an important tool for extending the duration and improving reliability for aerosol jet printing, a key factor for integration of aerosol jet printing in practical manufacturing operations.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to additive manufacturing and, in particular, to a recirculating ink cartridge for aerosol jet printing.

### BACKGROUND OF THE INVENTION

Printed, flexible, and hybrid electronics offer a compelling platform for emerging applications spanning consumer devices, wireless connectivity, and distributed sensing. See K. Fukuda and T. Someya, Adv. Mater. 29, 1602736 (2017); D. Lupo et al., Applications of Organic and Printed Electronics, ed E Cantatore (Boston, Mass.: Springer) (2013); and A. Nathan et al., Proc. IEEE 100, 1486 (2012). Among the relevant manufacturing technologies for these systems, digital techniques are well-suited to rapid prototyping and smart fabrication. Aerosol jet printing (AJP), in particular, offers a promising combination of digital control, non-contact deposition, fine patterning resolution, and broad materials compatibility. See J. M. Hoey et al., J. Nanotechnol. 2012, 324380 (2012); P. Sarobol et al., Annu. Rev. Mater. Res. 46, 41 (2016); and N. J. Wilkinson et al., Int. J. Adv. Manuf. Tech. 105, 4599 (2019). Based on these attributes, AJP has attracted interest for hybrid electronics manufacturing, logic circuits, energy devices, and sensors. See K. K. Christenson et al., Digital Printing of Circuit Boards Using Aerosol Jet. In: International Conference on Digital Printing Technologies, Society for Imaging Science and Technology, 433 (2011); M. S. Saleh et al., Sci. Adv. 3, e1601986 (2017); T. Seifert et al., Mater. Today-Proc. 2015, 2(8), 4262 (2015); C. Cao et al., Adv. Electron. Mater. 3, 1700057 (2017); M. Ha et al., ACS Nano 4, 4388 (2010); K. Hong et al., Adv. Mater. 26, 7032 (2014); S. Bag et al., Adv. Energy Mater. 7, 1701151 (2017); A. Mette et al., Prog. Photovolt., Res. Appl. 15, 621 (2007); B. A. Williams et al., ACS Appl. Mater. Interfaces 7, 11526 (2015); R. Eckstein et al., Adv. Electron. Mater. 1, 1500101 (2015); and D. Zhao et al., Smart Mater. Struct. 21(11), 115008 (2012).

Despite its potential, more widespread adoption of AJP is hindered by process drift. While seldom discussed in research papers, the aerosol deposition rate can vary significantly during printing, even over relatively short print durations. See M. Smith et al., Flex. Print. Electronics 2, 015004 (2017). This is a notable barrier to industrial applications, leads to significant material waste, and confounds process optimization efforts. See Y. Gu et al., J. Micromech. Microeng. 27, 097001 (2017). While strategies have been introduced to monitor and respond to process drift, these strategies do not address underlying causes. See Y. Gu et al., J. Micromech. Microeng. 27, 097001 (2017); R. Salary et al., J. Manuf. Sci. Eng. 139, 101010 (2017); and R. Salary et al., J. Manuf. Sci. Eng. 139, 021015 (2017).

FIG. 1 illustrates the key physical processes involved in aerosol jet printing. During aerosol jet printing, a liquid ink containing functional nanomaterials is atomized in an ink cartridge to produce 1-5 μm droplets. These droplets are picked up by a carrier gas stream and transported to a printhead, where an annular sheath gas flow is introduced that surrounds the aerosol stream. This sheath gas collimates the aerosol flow and accelerates it through a narrow deposition nozzle, typically 100-300 μm in diameter. Under typical conditions, this results in a 10-100 m/s jet originating 1-5 mm above a substrate. The high inertia of the aerosol droplets causes them to be aerodynamically focused by the gas flow stream prior to impacting the substrate, resulting in high resolution (20-100 μm) features. See E. B. Secor, Flex. Print. Electronics 3, 035002 (2018); and N. J. Wilkinson et al., Int. J. Adv. Manuf. Technol. 105, 4599 (2019), which are incorporated herein by reference.

Process drift can arise from several sources, including variation in atomization yield and ink composition, both of which affect drying kinetics within the printhead and can lead to poor outcomes. See E. B. Secor, Flex. Print. Electronics 3, 035007 (2018). Depending on the ink and process parameters, this drift can be significant. For example, Smith, et al. observed a doubling in the cross-sectional area of silver lines after only ˜20 minutes printing. See M. Smith et al., Flex. Print. Electronics 2, 015004 (2017). However, the majority of published reports entirely neglect to report print stability results. While process drift is present, efforts to optimize the process face significant challenges. In some cases, this drift leads researchers to discard ink and refill the cartridge periodically, leading to severe material waste. Process drift is also a clear barrier to more widespread industrial adoption of AJP, in that print stability and reliability are prerequisites and, in many cases, more critical than peak performance metrics, such as resolution.

Therefore, a need remains to understand the underlying causes of process drift during aerosol jet printing and to mitigate this problem at its source.

### SUMMARY OF THE INVENTION

The present invention is directed to a recirculating ink cartridge for an aerosol jet printer, comprising an ink cartridge comprising an aerosol generator that generates aerosol droplets from a volume of liquid ink for transport in a carrier gas to a printhead; and a recirculating ink system, comprising an external reservoir for holding a source of the ink, and a pump for adding ink from the external reservoir to the ink cartridge and returning ink from the ink cartridge to the external reservoir. The amount of ink added to the ink cartridge from the external reservoir and the amount of ink returned to the external reservoir from the ink cartridge can be controlled to maintain the ink level in the cartridge during printing. For example, the initial volume of ink in the external reservoir can be greater than five times the ink level in the ink cartridge. For example, the aerosol generator can comprise an ultrasonic atomizer or a pneumatic atomizer. For example, the ink can comprise nanoparticles dispersed in a solvent or a polymer dissolved in a solvent.

Maintaining the ink level in the ink cartridge during aerosol jet printing enables extended print duration with little systematic drift. Further, by decoupling the ink volume in the cartridge from the external reservoir, small composition changes can be buffered. Further, improving access external to the cartridge enables monitoring the ink, rather than the aerosol stream, thereby addressing a direct cause of process drift rather than a symptom. Finally, the recirculation method can be combined with higher level monitoring and feedback strategies.

### BRIEF DESCRIPTION OF THE DRAWINGS

The detailed description will refer to the following drawings, wherein like elements are referred to by like numbers.

FIG. 1 is a schematic illustration of an aerosol jet printer.

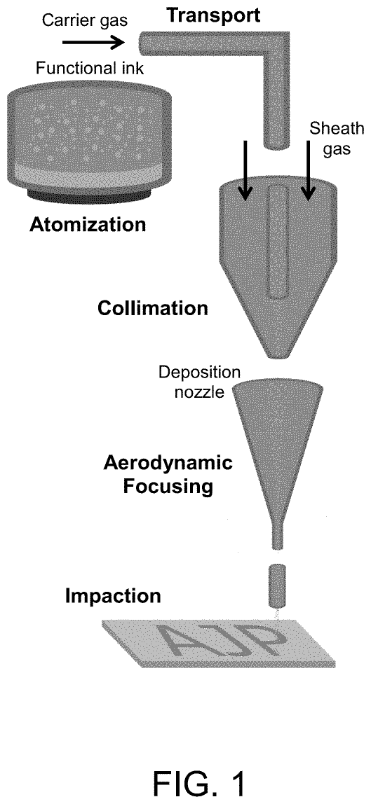

FIG. 2 is a schematic illustration of an ink cartridge with ultrasonic atomization. Two principle causes of process drift are changes in ink composition and volume during printing.

FIG. 3A is a graph of film thickness and line width as a function of print time, showing severe drift over six hours of continuous printing in a control case, with no solvent bubbler and a standard ink cartridge design. FIG. 3B shows optical microscopy images of printing lines at various points during the six hour print run, showing clear reduction in the amount of material deposited.

FIGS. 4A and 4B are graphs of results from a simple model of ink composition and volume change within the ink cartridge over six hours, based on drying induced by the carrier gas. Plotted lines show ink volume (black), primary solvent volume fraction (red), cosolvent volume fraction (blue), and solids loading (green) on both an absolute (FIG. 4A) and relative (FIG. 4B) basis.

FIG. 5A is a photograph of sample printed over six hours using a solvent bubbler to pre-saturate the carrier gas stream, showing visible changes in appearance reflecting the process inconsistency. FIG. 5B is a graph of film thickness and line width measurements over six hours of printing, showing a significant reduction in both metrics beginning after ˜2 hrs. of printing. FIG. 5C shows optical microscopy images of lines printed at various stages during the six hour print, showing a clear reduction in line width as the print progressed.

FIG. 6A is a graph of film thickness plotted as a function of atomizer voltage, for cartridge ink loading levels of 0.5-3.0 g in 0.5 g increments. At low and high cartridge loading, the deposition rate saturates at a low value. FIG. 6B is a graph of film thickness plotted against both cartridge loading (x-axis) and atomizer voltage (y-axis), showing a clear change in deposition rate at a fixed voltage, corresponding to long-duration printing in which the cartridge ink loading monotonically decreases.

FIG. 7A is a schematic illustration of a recirculating ink system, in which ink is continuously pumped between the ink cartridge and an external reservoir with a computer-controlled peristaltic pump. FIG. 7B is a 3D model of the ink cartridge, which is modified to accommodate tubing for the recirculating ink in addition to the regular tubing ports for the gas flows.

FIG. 8A shows photographs of films printed over 30 hrs. of printing in five separate runs, with the ink loaded only once. FIG. 8B are graphs of film thickness over 30 hrs. of printing, showing some fluctuations but without the systematic drift observed in prior studies. FIG. 8C shows optical microscopy images of printed lines at 2 hr. intervals over 30 hrs., showing reasonable consistency in line width and appearance.

### DETAILED DESCRIPTION OF THE INVENTION

The present invention is directed to a recirculating ink cartridge for aerosol jet printing that improves stability and allows for extended duration printing. The recirculating ink cartridge addresses the underlying causes of drift related to variation in the ink composition and loading level. For example, printing over a period of 30 hours during 5 separate production runs has been demonstrated using this recirculating ink cartridge, promising to improve the application scope and industrial relevance of aerosol jet printing.

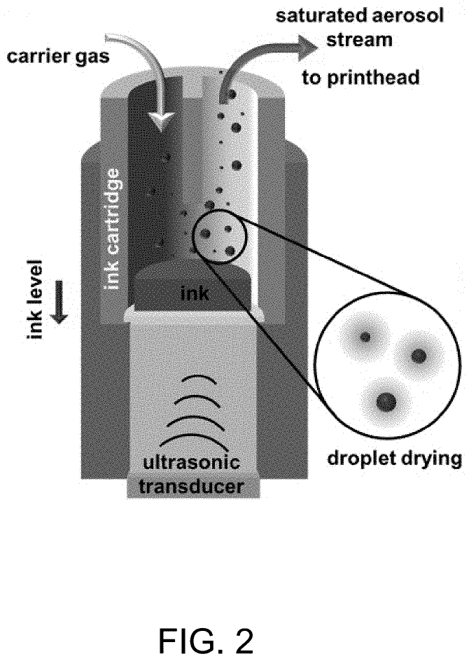

Experiments to determine the underlying causes of process drift were conducted using a custom-built printer based on a modified Integrated Deposition Solutions (IDS) NanoJet™ system. See E. B. Secor, Flex. Print. Electronics 3, 035007 (2018); E. B. Secor, Flex. Print. Electronics 3, 035002 (2018); and U.S. Pat. No. 10,124,602, which are incorporated herein by reference. This printer uses an ultrasonic atomizer and a compact ink cartridge to generate an aerosol stream, as shown in FIG. 2. A volume of ink is placed in acoustic contact with the ultrasonic atomizer, either via direct contact with the vibrating surface of the ultrasonic transducer or separated from it by a thin membrane and/or a coupling fluid. High frequency (MHz) ultrasound sets up a capillary wave on the ink surface, leading droplets to break off with a fairly well-defined size distribution. The ink viscosity and amount determine the critical power required for atomization, as the ultrasonic wave must propagate through the liquid to the surface with limited viscous damping. The droplet size generated is related to the capillary wavelength, determined by the ultrasound frequency, the ink density, and the ink surface tension. Due to their micron-scale size, the aerosol droplets quickly lose solvent upon contact with a dry gas stream. The resulting reduction in drop size facilitates uptake in the aerosol carrier gas stream, which is expected to become saturated with solvent vapor on a timescale of seconds under typical operating conditions. The ink cartridge is located immediately adjacent to the printhead (not shown), thereby reducing the aerosol transport distance and limiting the gravitational settling of droplets in route to the printhead. The printhead used a 250 μm diameter nozzle orifice. Typical printing conditions for these experiments were 36 V atomizer setting, 8-14 sccm aerosol carrier gas flow rate, a sheath flow rate of 3× the aerosol flow rate, 17° C. cartridge temperature, 60° C. substrate temperature, and a print speed of 2.5 mm/s. Following printing, all samples were heated to 150° C. for 45 minutes to ensure complete drying.

Printing experiments were performed with the ink cartridge shown in FIG. 2 to assess the effects of process drift. These experiments used a magnetite nanoparticle ink based on commercially available nanoparticles from UT Dots, Inc. The base material, UTDMI-SD, is a viscous paste containing magnetite nanoparticles in xylenes. A stock solution was prepared from this by diluting the paste with xylenes in a 1:4 UTDMI:xylenes ratio (w/w). A wet ink for aerosol jet printing was prepared by combining this stock solution, xylenes, and terpineol in a 5:31:4 (v/v) mixture. This ink was mixed using a laboratory shaker to yield a low viscosity, brown dispersion. An initial volume of 2 mL ink was used for these stability experiments. For typical printing run, a series of 2×2 mm films was printed, each one designed to take 3 minutes. After each set of 10 films, a line was printed to track line width during the process. Following printing and drying, the thickness of each film was measured by stylus profilometry and correlated to the print time. This allowed straightforward analysis of drift in the deposition rate. While variation in the resolution was tracked, it was given lower priority, as the resolution is principally related to gas flow rates and nozzle dimensions which were fixed. Variation in the deposition rate will have indirect effects on resolution, however, so stability in this metric is critical to the process overall and representative of process drift.

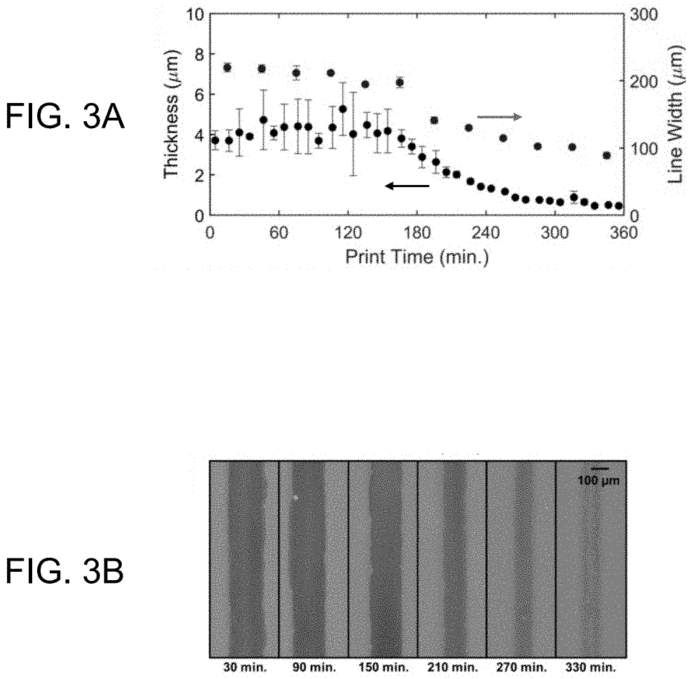

A standard printing run was performed as a control experiment to assess the effects of process drift. The results for this baseline test are shown in FIGS. 3A and 3B. Over the first 150 minutes of printing, the deposition is fairly consistent, including both the deposition rate (as measured by film thickness) and the line width. However, after this initial stable period, the deposition rate falls off dramatically, ultimately reaching a level of 12.5±1.0% of the initial value following six hours of printing. The line width shows a similar change resulting from the reduction in deposition rate, decreasing from 219±6 μm in the first hour to 95±7 μm in the sixth hour. Both of these effects are consistent with a reduction in the ink atomization, and thus a lower aerosol density. This behavior is typical for aerosol jet printing, and presents an impediment to broader applications of the technology.

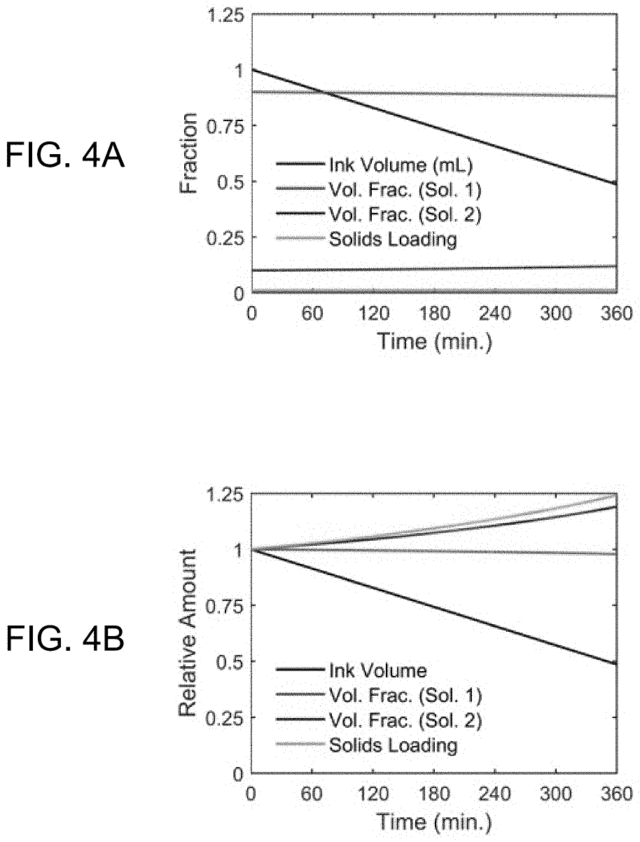

The first cause of drift is related to variation in the ink composition. During the baseline test, a dry carrier gas was continuously flowing through the ink cartridge. Micron-scale droplets feature evaporation timescales on the order of milliseconds, and therefore solvent is continuously removed from the cartridge. See J. F. Widmann and E. J. Davis, Aerosol Sci. Technol. 27, 243 (1997); and B. A. Williams et al., ACS Appl. Mater. Interfaces 9, 18865 (2017). Drift in ink volume and composition within the cartridge was modeled as a function of time under steady printing conditions. The results of this modeling are shown in FIGS. 4A and 4B. The model assumed a two-component ink solvent systems based on a primary, moderate volatility solvent and a secondary, less volatile cosolvent at 5-20%. A low-volatility cosolvent is typically added to prevent complete drying of the aerosol droplets. See K. Hong et al., Adv. Mater. 26, 7032 (2014); and A. Mahajan et al., ACS Appl. Mater. Interfaces 5, 4856 (2013). Due to the rapid nature of evaporation from micron-scale droplets, both solvents are expected to saturate the carrier gas. The low-volatility cosolvent typically has a much lower saturation vapor pressure, causing this low-volatility cosolvent to be enhanced relative to the primary solvent. This can affect downstream drying effects induced by the sheath gas in the printhead, potentially increasing the apparent deposition rate. In addition to this change in solvent composition, the solids loading of the remaining ink increases in the cartridge. For inks near the threshold of atomization, a small resulting increase in viscosity can reduce atomization yield, thereby reducing deposition onto the substrate. This illustrates how process drift can lead to unexpected outcomes, with both an increase and a decrease in deposition rate possible. As this cause of drift is well known, a partial solution is also widely adopted, namely running the carrier gas through a solvent bubbler upstream of the printhead. Therefore, drift can be mitigated by pre-saturating the aerosol carrier gas. Drift can also be reduced by using low volatility solvents (minimizing evaporation within the cartridge).

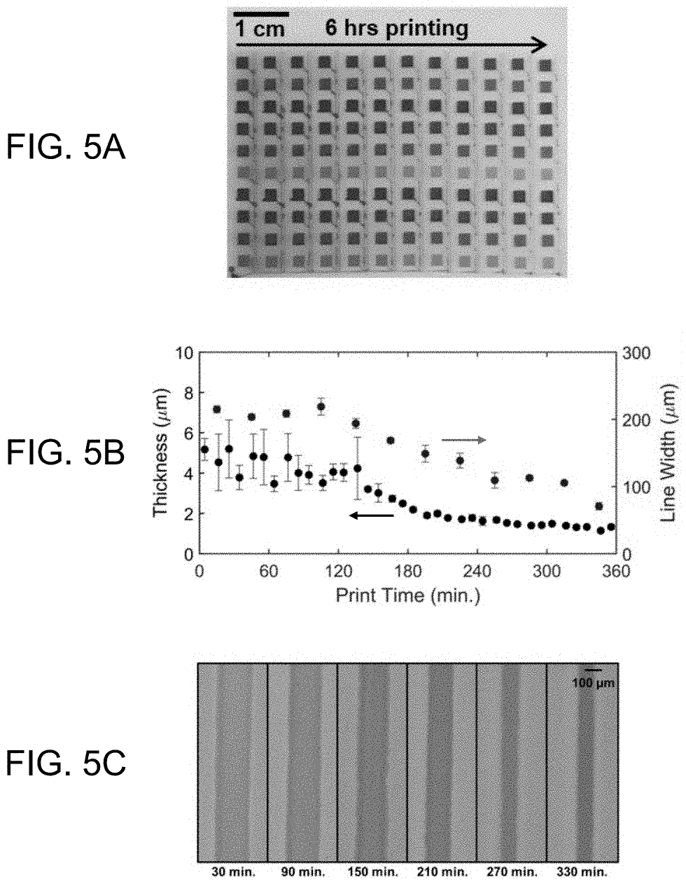

When this pre-saturation strategy is implemented, overall printing stability is improved somewhat. FIG. 5A shows a photograph of a test sample layout for a six hour print test. Drift during printing, as judged by optical appearance, can be discerned by eye. This observed difference is corroborated by film thickness and line width measurements, shown in FIG. 5B. Similar to the previous case without a solvent bubbler, the ink initially prints with reasonable stability for ˜150 minutes. Following this period, a decrease in deposition rate is again observed, with the final film thickness after six hours reduced to 25.5±2.9% of the initial value. As shown in FIG. 5C, the line width also reflects this reduction in aerosol density, with a decrease from 209±7 μm in the first hour to 88±19 μm in the sixth hour. This suggests that, while ink composition drift can have an impact, it is not the sole basis for process inconsistency. Based on the model, even if the solvent bubbler perfectly compensates for ink drying, the very process of printing changes another parameter that can affect stability, namely the volume of ink in the cartridge.

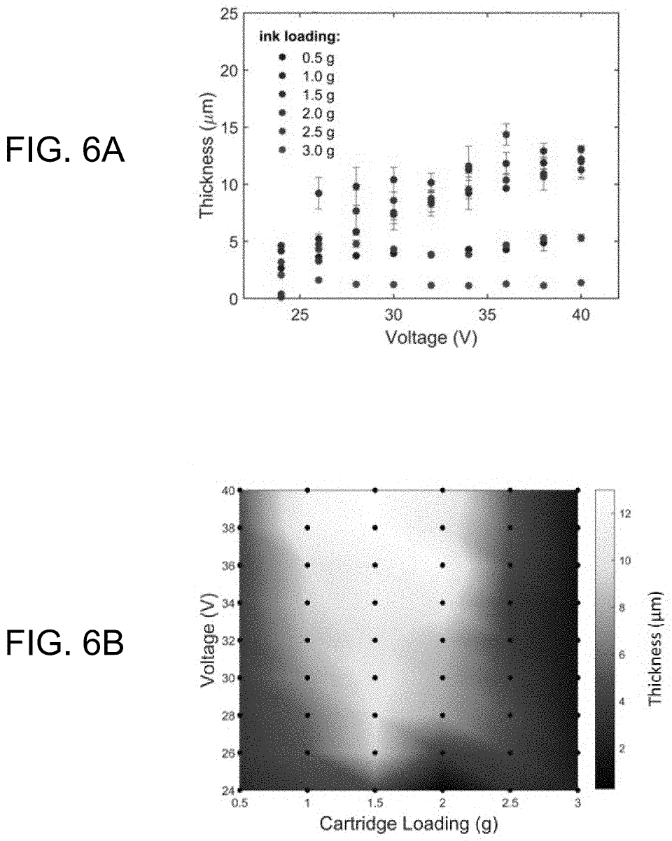

To assess the impact of the ink volume on printing, a careful study was performed in which the ink loading level was deliberately manipulated to study its effect independent of composition variations. At each ink loading level, a sweep of atomizer voltage was performed to determine the impacts of both of these parameters on atomization yield. The results are shown in FIG. 6A. At low ink loading levels, the deposition rate, here measured by the film thickness, saturates at fairly low values. In this regime, the deposition rate is relatively insensitive to variations in voltage, but the overall film thickness remains low. With a moderate ink loading (1.0-2.0 g), the film thickness increases steadily with increasing voltage. However, when the ink loading exceeds this range, the film thickness again shows saturation at low values. This suggests that the atomization yield is directly related to the ink volume in the cartridge. Moreover, when the ink volume is outside of the target range, increasing the atomization power has almost no impact on atomization yield. The primary cause of this is likely the location of the liquid surface relative to the ultrasonic atomizer. Ultrasonic nebulizers are expected to display this behavior, as the ultrasonic waves are focused on the liquid surface for maximum coupling. See A. M. Al-Jumaily and A. Meshkinzar, Adv. Acoust. Vib. 2017, U.S. Pat. No. 7,861,726 (2017); and J. C. Simon et al., J. Fluid Mech. 766, 129 (2015). In many cases, this effect of the ink level can dominate any effects of atomizer voltage, and modulating the atomizer power cannot compensate for reduction in deposition rate due to ink level changes. This has important implications for extended duration printing because the liquid level is not consistent over the duration of the print. Therefore, even if the ink composition is maintained, ink utilized for printing or loss due to settling in the mist tube will affect the atomization characteristics. This is illustrated in FIG. 6B, which plots the measured thickness against both cartridge loading and voltage. For a long-duration print, the voltage remains consistent, but the cartridge loading is gradually reduced. As the plot is traversed from right to left, the deposition rate initially increases to its maximum value, and then decreases, with a limited plateau. This explains the results in FIG. 5B. With an initial ink loading of ˜1.9 g, the atomization is initially near its peak efficacy. As printing progresses, the state of the cartridge moves leftward in FIG. 6B, and the deposition rate drops off rather significantly after ˜2 hrs print time. This behavior illustrates the challenge faced in achieving stable and consistent aerosol jet printing, and suggests that, depending on where printing starts, either an increase or decrease in atomization is expected not as an isolated problem based on the particular ink, but as an inherent feature of the atomization method itself. Moreover, a change in atomization yield will have downstream effects, including a direct impact on deposition rate and indirect impacts on line resolution and morphology.

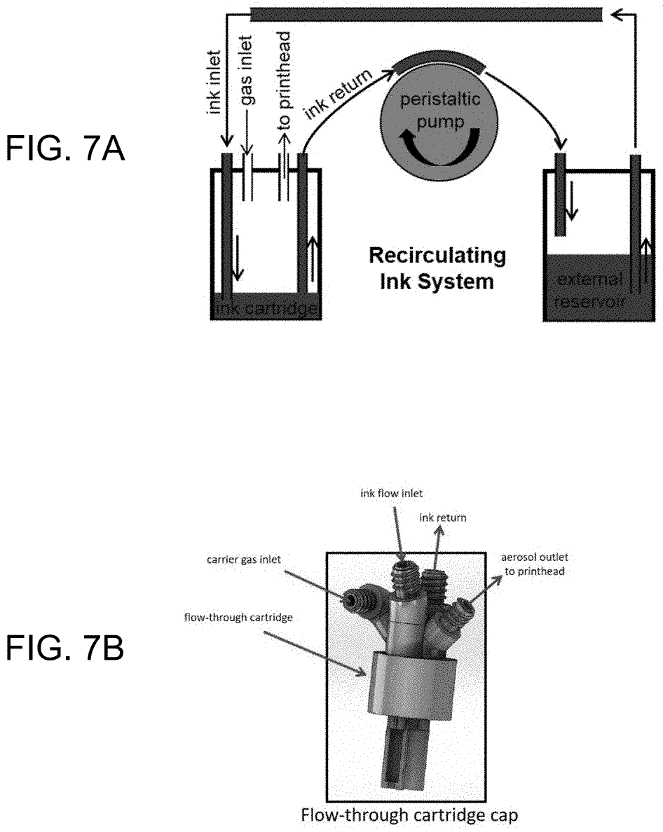

The identification of ink level as a critical factor in atomization yield motivates strategies to mitigate this cause of drift. Direct addition of ink or solvent to the cartridge is possible, but would need to be perfectly compensated to the ink usage, which precludes generalization in a straightforward manner given the wide variation in inks and process parameters used. Therefore, the present invention is directed toward a recirculating ink cartridge to both maintain ink level in the cartridge and buffer slow changes in ink composition with ink from a larger external reservoir, as shown in FIG. 7A. In order to implement this invention, the ink cartridge was redesigned as a flow-though ink cartridge and fabricated using stereolithography to accommodate tubing, as shown in FIG. 7B. A peristaltic pump can be used to circulate the ink between the ink cartridge and the external reservoir, providing control over recirculation speed and direction using a microcontroller to drive the pump.

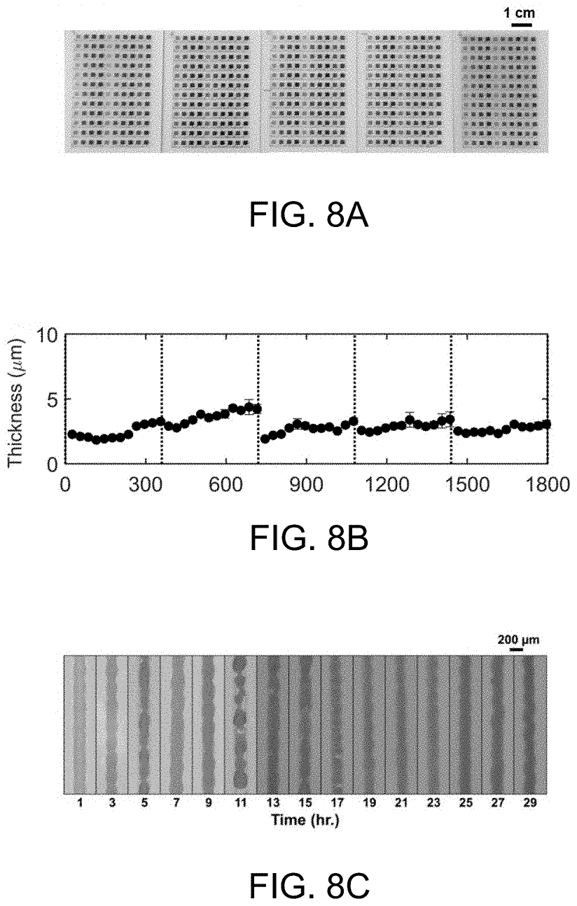

Using this recirculating ink cartridge, an extended duration test of printing stability was performed using the magnetite nanoparticle ink. As before, large grids of 2×2 mm films were used to track the deposition rate. As shown in FIG. 8A, optical images of the samples illustrate a reasonable degree of uniformity over 30 hours of printing spanning 5 print runs. As shown in FIG. 8B, the film thickness measurements corroborate this uniformity, showing some fluctuations but limited systematic drift over the duration of printing. While some variation is clear, particularly on the third print run, this is reset at the beginning of the following run and does not propagate from run-to-run. Therefore, such effects can be avoided by programming stops during the print run at regular intervals to reset the system. Indeed, the film thickness increases to 131±13% of the initial value following 30 hrs printing. During the last 18 hrs of printing, the measured film thickness varies with a relative standard deviation of 17%. Analysis of the printed lines, shown in FIG. 8C, is consistent with these results, with a 9.4% relative standard deviation in line width over the full 30 hrs. In addition, although a solvent bubbler was used in these experiments it is not expected to fully saturate the carrier gas, and thus small changes in composition can be expected. The use of an external reservoir, in this case with 10 mL ink initially loaded, will buffer these changes over a larger volume. At the end of 30 hours of printing, the amount of ink in the reservoir was decreased to the extent that air was being drawn into the pump, thus prompting the end of the experiment. However, for applications requiring a longer print duration, simply increasing the reservoir size is straightforward and economical.

In general, the invention is independent of the specific ink properties, and can thus be applied to alternative materials, providing a practical and general tool to address drift in aerosol jet printing. For example, the ink can comprise a wide variety of nanoparticles dispersed in a solvent. For example, the nanoparticles can comprise ceramic, glass, metal, non-metal, semiconductors, polymer, composite, layered, core-shell, or biological nanomaterials. Typically, the nanoparticles can be between 1 and 100 nanometers in size. Alternatively, the ink can comprise a polymer dissolved in a solvent, wherein the solvent evaporates during printing. For example, the polymer can comprise a polyimide or polymethyl methacrylate. Other types of aerosol generators can also be used. For example, pnenumatic aerosol generators can also be used. See, for example, A. Wadhwa, “Run-time Ink Stability in Pneumatic Aerosol Jet Printing Using a Split Solvent Add Back System,” (2015). Thesis, Rochester Institute of Technology; and R. Salary et al., J. Manuf. Sci. Eng. 139, 021015 (2017), which are incorporated herein by reference.

The present invention has been described as a recirculating cartridge for aerosol jet printing. It will be understood that the above description is merely illustrative of the applications of the principles of the present invention, the scope of which is to be determined by the claims viewed in light of the specification. Other variants and modifications of the invention will be apparent to those of skill in the art.

1. A recirculating ink cartridge for an aerosol jet printer, comprising:
an ink cartridge comprising an aerosol generator that generates aerosol droplets from a volume of liquid ink for transport in a carrier gas to a printhead; and
a recirculating ink system, comprising
an external reservoir for holding a source of the ink, and
a pump for adding ink from the external reservoir to the ink cartridge and returning ink from the ink cartridge to the external reservoir;
wherein the amount of ink added to the ink cartridge from the external reservoir and the amount of ink returned to the external reservoir from the ink cartridge is controlled to maintain an ink level in the cartridge during printing.

2. (canceled)

3. The recirculating ink cartridge of claim 1, wherein the initial volume of ink in the external reservoir is greater than five times the ink level in the ink cartridge.

4. The recirculating ink cartridge of claim 1, wherein the aerosol generator comprises an ultrasonic atomizer.

5. The recirculating ink cartridge of claim 1, wherein the aerosol generator comprises a pneumatic atomizer.

6. The recirculating ink cartridge of claim 1, wherein the ink comprises nanoparticles dispersed in a solvent.

7. The recirculating ink cartridge of claim 6, wherein the nanoparticles comprise ceramic, glass, metal, non-metal, semiconductors, polymer, composite, layered, core-shell, or biological nanomaterials

8. The recirculating ink cartridge of claim 1, wherein the ink comprises a polymer dissolved in a solvent.

9. The recirculating ink cartridge of claim 8, wherein the polymer comprises polyimide or polymethyl methacrylate.

10. The recirculating ink cartridge of claim 1, further comprising a solvent bubbler for pre-saturating the carrier gas.
